(19) United States
(12) Patent Application Publication
(10) Pub. No.: US 2013/0037362 A1
(43) Pub. Date: Feb. 14, 2013

(54) DAMPING AND INERTIAL HYDRAULIC DEVICE

(71) Applicants: Bill J. Gartner, Wyomissing, PA (US); Malcolm C. Smith, Cambridge (GB)

(72) Inventors: Bill J. Gartner, Wyomissing, PA (US); Malcolm C. Smith, Cambridge (GB)

(21) Appl. No.: 13/577,234

(22) PCT Filed: Feb. 7, 2011
(86) PCT No.: PCT/GB11/00160

§ 371 Date: Oct. 22, 2012

Related U.S. Application Data
(60) Provisional application No. 61/301,891, filed on Feb. 5, 2010.

(51) Int. Cl. F16F 7/10; F16F 9/504; F16F 9/18; F16F 9/53; B60G 13/16; F16F 9/06

(52) U.S. Cl. 188/378; 188/315; 188/269; 188/267.2; 188/275

(57) ABSTRACT

A device for use in the control of mechanical forces. The device comprises first and second terminals for connection, in use, to components in a system for controlling mechanical forces and independently moveable (2, 3). Hydraulic means are connected between the terminals and contain a liquid, the hydraulic means configured, in 4 use, to produce upon relative movement of the terminals, a liquid (4) flow along at least two flow paths (5, 15, 90). The liquid flow along a first flow path generates a damping force proportional to the velocity of the liquid flow along the first flow path, and the liquid flow along a second flow path generates an inertial force due to the mass of the liquid, the force being substantially proportional to the acceleration of the liquid flow along the second flow path, such that the damping force is equal to the inertial force and controls the mechanical forces at the terminals.

This invention relates to an integrated damping and inertial device for controlling mechanical forces such as vibrational forces.

Force-controlling devices are present in a number of applications and are used for example in vehicle suspension systems. An example mechanical device is disclosed in U.S. Pat. No. 7,316,303B (the “inerter”) and provides a component for building a suspension system with any desired mechanical impedance. This device can include a linear to rotary transducer, connected to a flywheel. Several variations of this device have been proposed, some including for example the use of ball screws or racks and pinions.

One disadvantage of all of these is that there is a considerable number of moving parts.

To address the above problem, force-controlling hydraulic devices have been proposed, wherein the number of moving parts is greatly reduced and tractability in production is increased. The force-controlling hydraulic devices can include a cylinder for containing a liquid, the cylinder being attached to one terminal; and a piston attached to another terminal and movable within the cylinder such that the movement of the piston causes the liquid flow along a flow path, such as a helical path. The moving liquid acts as storage for kinetic energy and generates an inertial force due to the mass of the liquid that controls the mechanical forces at the terminals such that they are substantially proportional to the relative acceleration between the terminals.

Some of the methods described in U.S. Pat. No. 7,316,303B to construct an arbitrary passive mechanical impedance include the interconnection of devices together with springs and dampers in a variety of circuit arrangements.

Some embodiments of the present invention seek to provide a device in which the inerter is implemented using a fluid, so that the number of moving parts is greatly reduced, and at the same time the integration with other passive circuit elements into a single unit is made possible. An example arrangement is an inerter in series with a damper.

The present invention enables fluid flow control, which provides a convenient method to achieve adjustability of the device.

Examples of various embodiments of the present invention will now be described with reference to the accompanying drawings, in which:

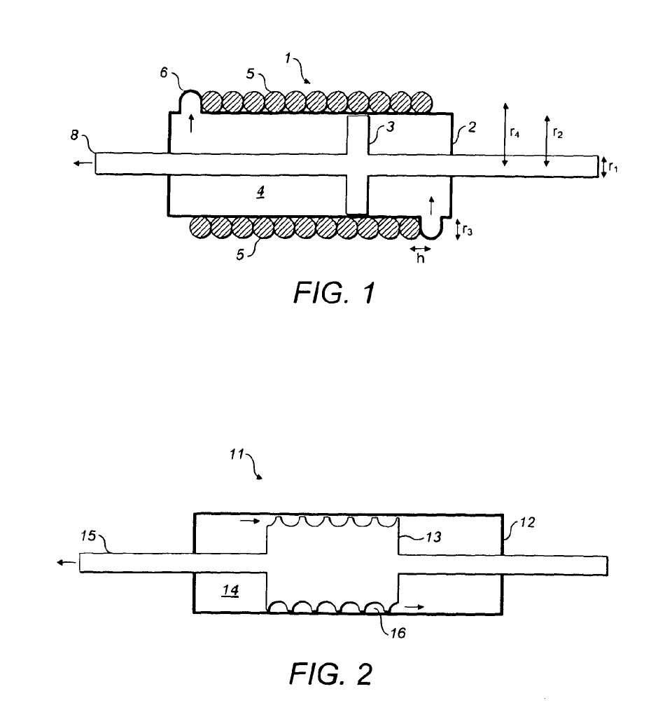

FIG. 1 is a schematic view of a force-controlling hydraulic device according to one embodiment of the present invention;

FIG. 2 is a schematic view of another force-controlling hydraulic device;

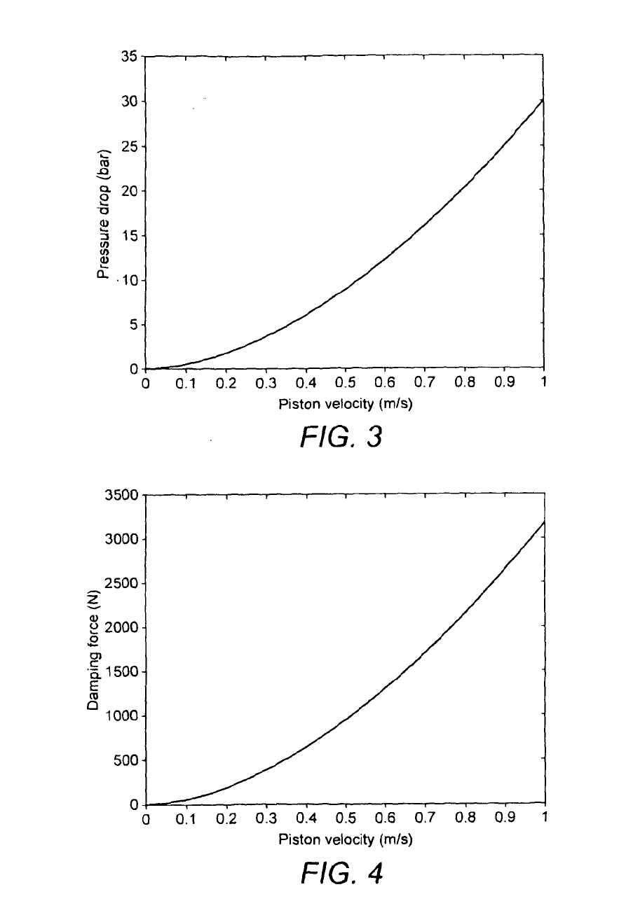

FIG. 3 shows the pressure drop across the device of FIG. 1 as a function of (constant) piston velocity;

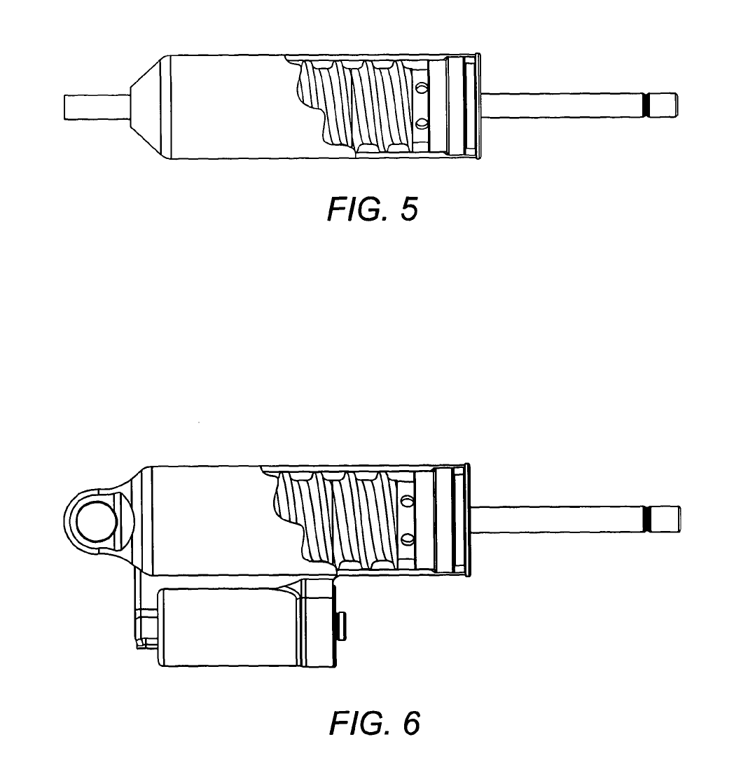

FIG. 4 shows the damping force on the piston of the device of FIG. 1 as a function of (constant) piston velocity;

FIG. 5 shows a fluid inerter according to another embodiment of the present invention with helix in piston and through-rod in partial cutaway view;

FIG. 6 shows a fluid inerter according to another embodiment of the present invention with helix in piston and pressurised gas reservoir in partial cutaway view;

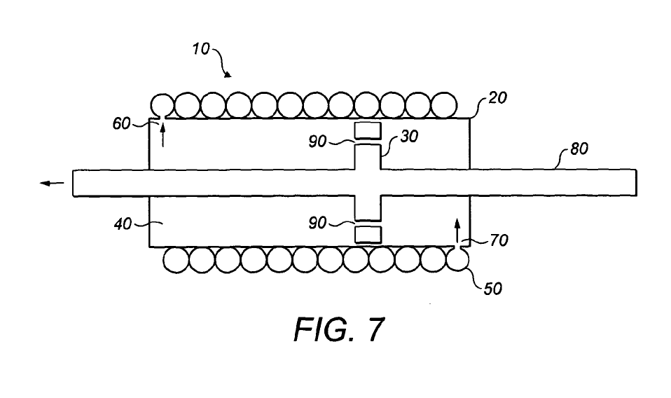

FIG. 7 shows a series inerter-damper according to another embodiment of the present invention in which the inerter is provided by means of an external helical path and the series damper is provided by damping means involving the fluid passing through an orifice within the piston;

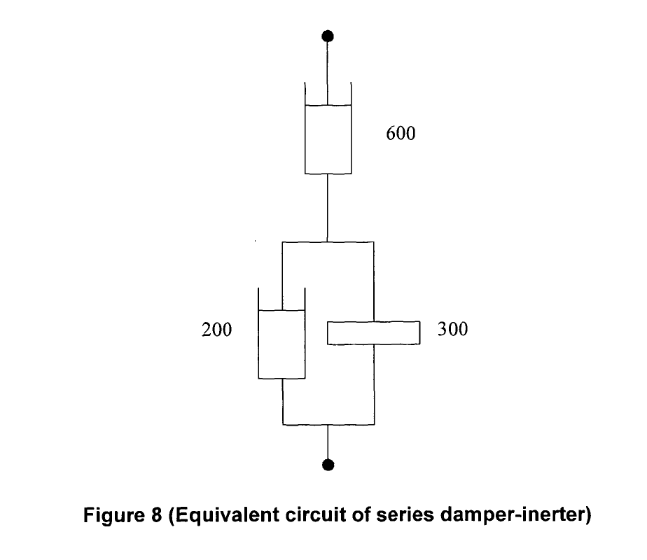

FIG. 8 represents the equivalent circuit of the device shown in FIG. 7;

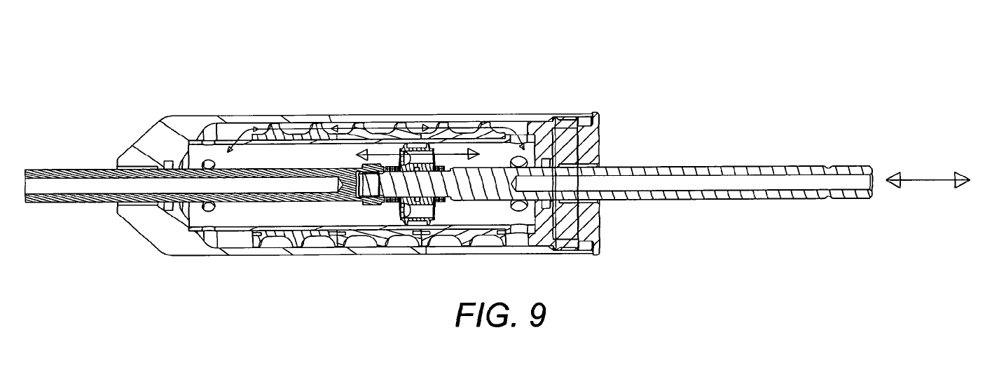

FIG. 9 shows a side elevational cross-sectional view of a series damper-inerter according to another embodiment of the present invention, designed as a twin-tube arrangement for construction of the external helical path and shaft mounted piston, with a through-rod;

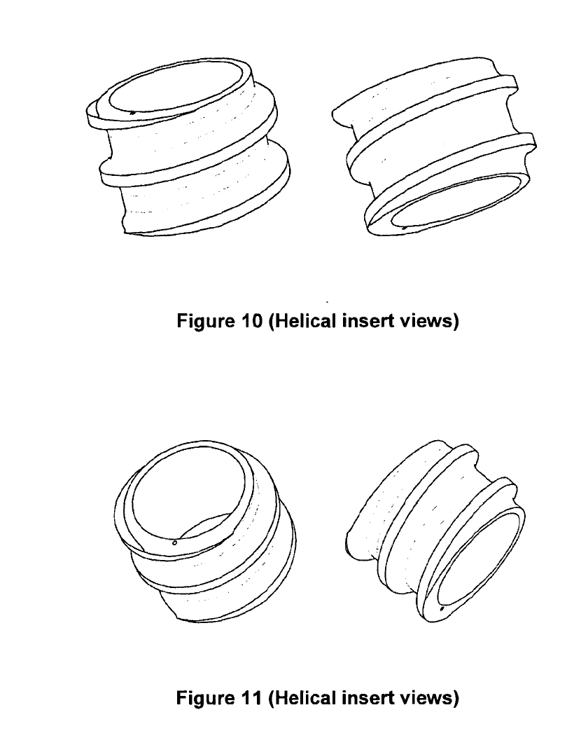

FIGS. 10 and 11 show external perspective views of helical inserts for the device shown in FIG. 9;

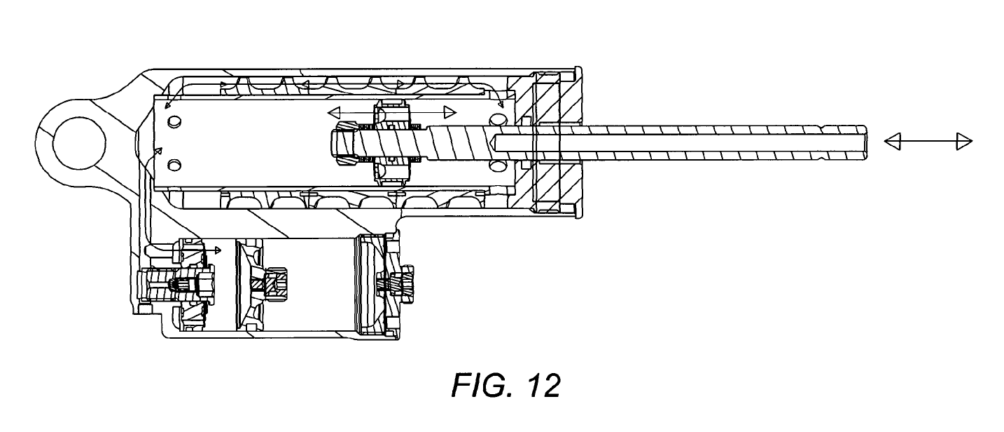

FIG. 12 shows a side elevational cross-sectional view of a series damper-inerter according to another embodiment of the present invention, designed as a twin-tube arrangement for construction of the external helical path and shaft mounted piston, and pressurised gas reservoir;

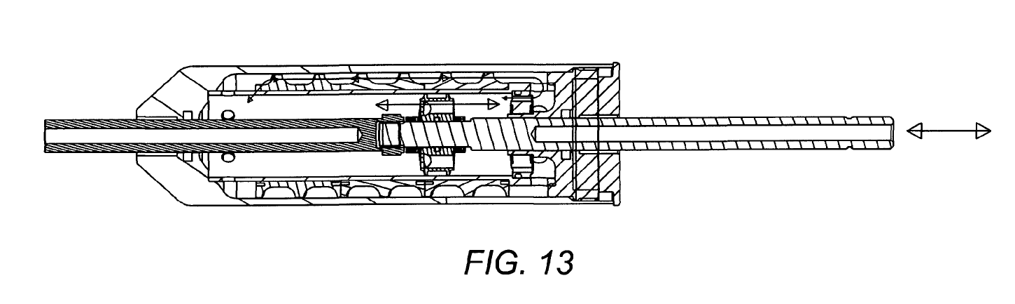

FIG. 13 shows a side elevational cross-sectional view of a series damper-inerter according to another embodiment of the present invention, designed as a twin-tube arrangement for the external helix, shaft mounted piston, a through-rod, and with a two-way damping piston added in line with the helical fluid path to modify the parasitic damping characteristic of the helical path;

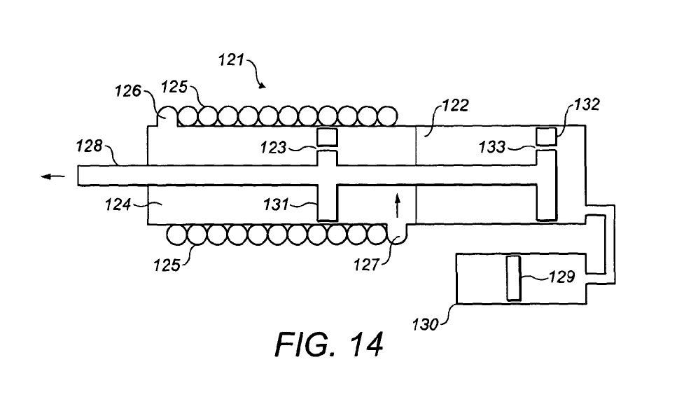

FIG. 14 shows a series damper inerter according to another embodiment of the present invention in parallel with a damper;

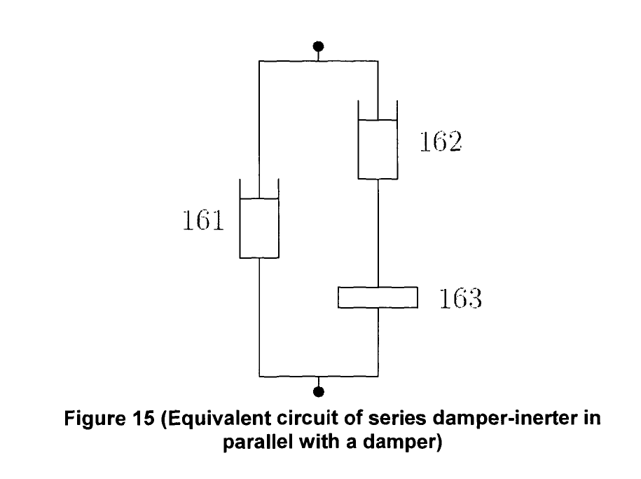

FIG. 15 represents the equivalent circuit of the device shown in FIG. 14;

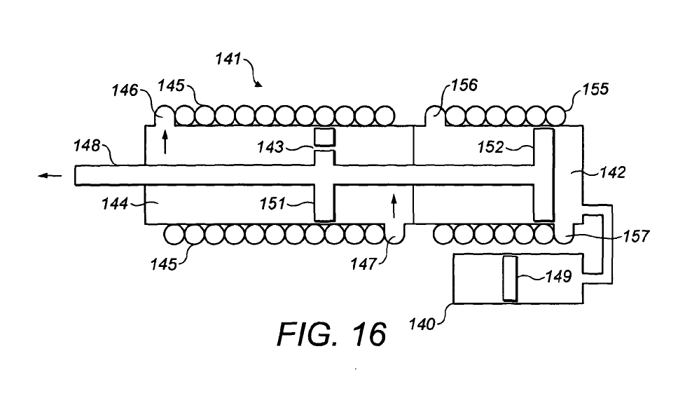

FIG. 16 shows a series damper inerter according to another embodiment of the present invention in parallel with an inerter;

FIG. 15 represents the equivalent circuit of the device shown in FIG. 16;

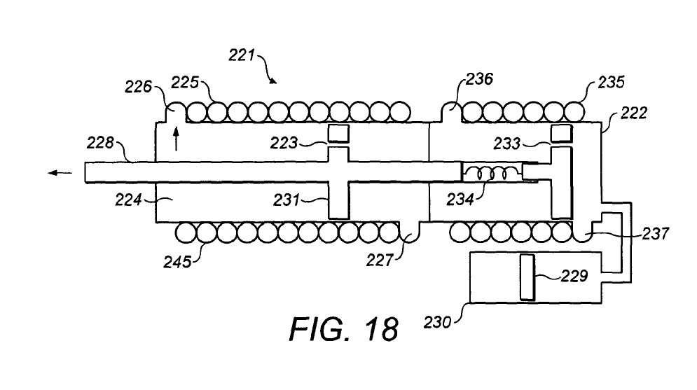

FIG. 18 shows a series damper inerter according to another embodiment of the present invention in parallel with a series connection of a spring damper and inerter;

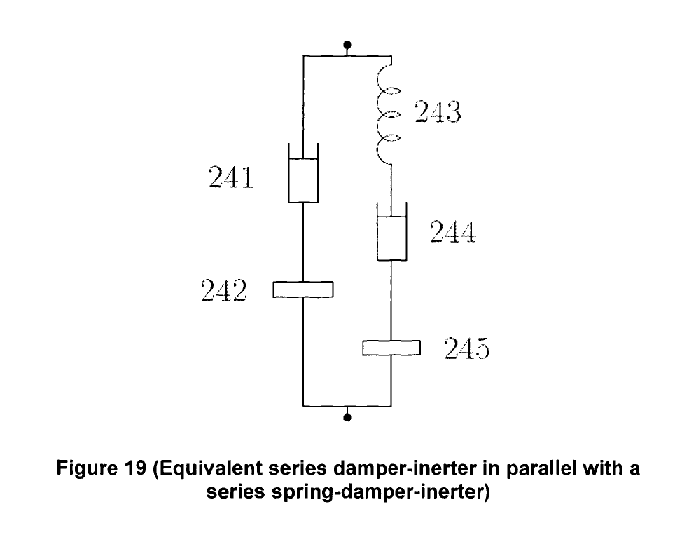

FIG. 19 represents the equivalent circuit of the device shown in FIG. 18;

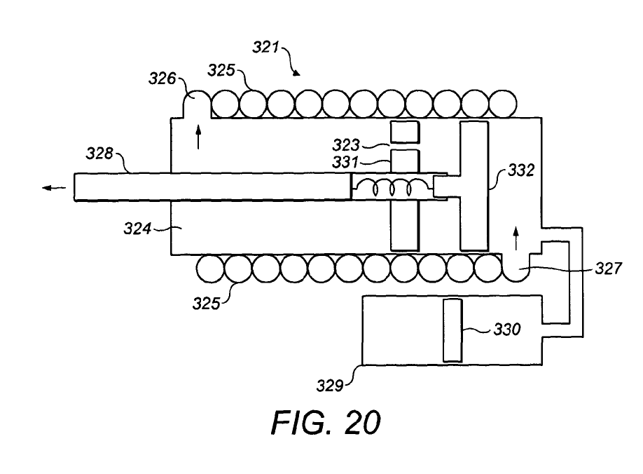

FIG. 20 shows an inerter in series with a parallel spring-damper according to another embodiment of the present invention;

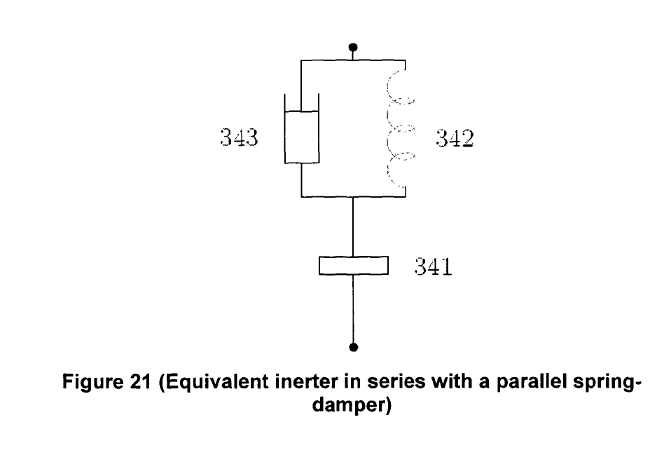

FIG. 21 represents the equivalent circuit of the device shown in FIG. 20;

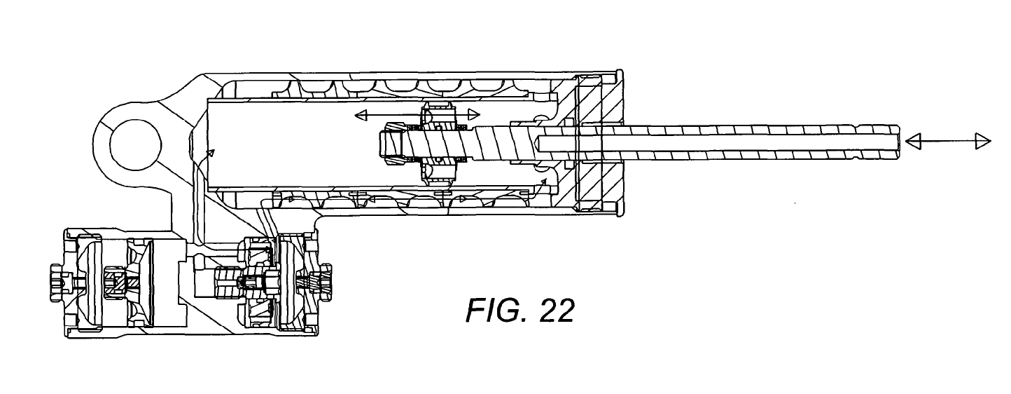

FIG. 22 represents a side elevational cross-sectional view of a series damper-inerter according to the present invention, designed as a twin-tube arrangement for the external helix, shaft mounted piston, pressurised gas reservoir, and with a through bi-directional piston to control flow in series with inertial flow;

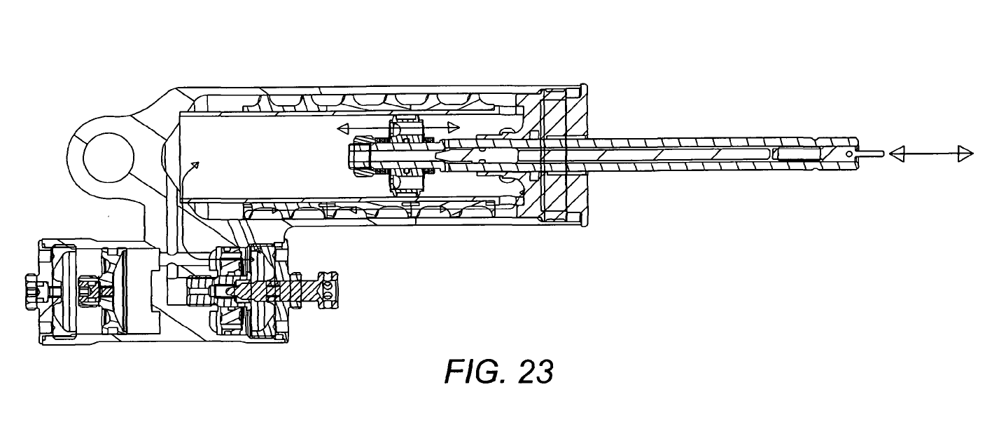

FIG. 23 represents a side elevational cross-sectional view of a series damper-inerter according to the present invention, designed as a twin-tube arrangement for the external helix, shaft mounted piston, pressurised gas reservoir, with a through bi-directional piston for controlling flow in series with inertial flow and external adjusters used to control the flow in the damping and inertial paths, respectively; and

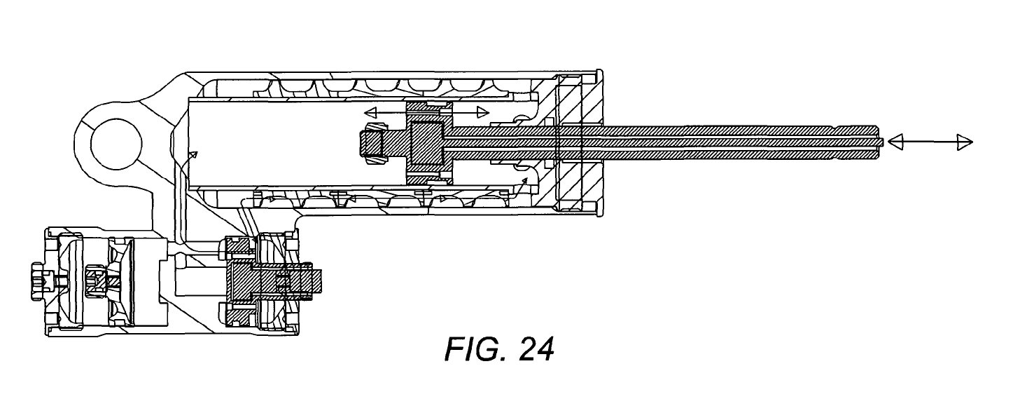

FIG. 24 represents a side elevational cross-sectional view of a series damper-inerter according to the present invention, designed as a twin-tube arrangement for the external helix, shaft mounted piston, pressurised gas reservoir, and a computer controlled flow valve or magnetic filed generator for controlling magnetorheological fluid.

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Prototypes of hydraulic force-controlling devices have been built and tested. These include one provided with a coil external to the cylinder as in FIG. 1 and using water as fluid, and another provided with an internal helical path shaped in the piston itself as shown in FIG. 2 and using hydraulic fluid.

FIG. 1 illustrates an example of a force-controlling hydraulic device 1. The device 1 comprises hydraulic means including independently movable terminals, which in this example, may be respectively included in a cylinder 2 and a piston 3 movable within the cylinder. A liquid 4 is contained within the cylinder 2. The device further comprises a helical tube 5 located outside the cylinder 2 creating a sealed path for the liquid to flow out and back into the cylinder 2 via two orifices (6, 7). The hydraulic means are configured to produce, upon relative movement of its terminals a liquid flow. Movement of the piston 3 causes liquid 4 to flow through helical tube 5 which generates an inertial force due to the moving mass of the liquid 4. The cylinder 2 may include one terminal, and the piston 3 may include another terminal. As will be explained below, the inertial force due to a moving mass of liquid caused by relative movement between the terminals controls the mechanical forces at the terminals such that they are substantially proportional to the relative acceleration between the terminals.

The motion of the piston 3 may be restricted by devices such as spring buffers (not shown). Such means may provide a useful safety feature to protect the device if large forces or velocities were generated at the limits of travel of the piston.

The device of FIG. 1 is implemented using a through-rod 8. Alternatives using a single rod with a floating piston or a double tube or other similar arrangements are equally feasible. It will be appreciated that alternative configurations for the hydraulic means are equally feasible with more specific embodiments being described below. Means to pressurise the fluid (not shown) are envisaged.

FIG. 2 illustrates another example of a force-controlling hydraulic device 11 according to the present invention. The device 11 comprises a cylinder 12, a piston 13 movable within the cylinder, and a liquid 14 within the cylinder 12. The outer surface of the piston 13 has a helical channel, such that, when inserted inside the cylinder 12, a helical path 15 is formed between the piston 13 and the cylinder 12. Movement of the piston 13 causes liquid 14 to flow through helical path 15 which generates an inertial force due to the moving mass of the liquid 14 inside the cylinder 12. In the example of

FIG. 2 the helical path 15 has a cross-section which is a semi-disc which is convenient for machining. Other cross-sectional shapes may also be employed with advantage to control the damping characteristics of the device. The example of FIG. 2 is implemented using a through-rod 15.

In the example shown in FIG. 1, the characteristic parameters of device 1, namely the constant of proportionality with which the applied force at the terminals is related to the relative acceleration between the terminals, can be varied by altering values such as the radii of the piston, cylinder, and helical tube, the length of the cylinder, and liquid density. The effect of such parameters will be detailed below.

Consider the arrangement shown in FIG. 1, where r₁ is the radius of the piston, r₂ is the inner radius of the cylinder, r₃ is the inner radius of the helical tube, r₄ is the radius of the helix, h is the pitch of the helix, n is the number of turns in the helix, L is the inner length of the cylinder, and p is the liquid density. Further,

A₁=π(r₂²−r₁²) is the cross-sectional area of the cylinder, and

A₂=πr₃² is the cross-sectional area of the tube.

The total mass of liquid in the helical tube is approximately equal to:

ρnπr₃²\sqrt{h²+(2πr₄)²}=:m_{hel.} (1)

The total mass of liquid in the cylinder is approximately equal to:

ρπ(r₂²−r₁²)L=:m_{cyl.} (2)

If the piston is subject to a linear displacement equal to x, then a fluid element in the helical tube may expect an angular displacement θ rads) approximately equal to:

$$\frac{2 π x ( {r}_{2}^{2} - {r}_{1}^{2} )}{r {3}^{2} \sqrt{{h}^{2} + {( 2 π {r}_{4} )}^{2}}} . \qquad ( 3 )$$

The moment of inertia of the total liquid mass in the helical tube about the axis of the piston is approximately equal to mₕₑₗr₄²=:J. Now suppose that device 1 has an ideal behaviour with b representing the proportionality constant wherein the generated inertial force between the terminals is proportional to the relative acceleration between the terminals. Then we would expect:

$$\frac{1}{2} b {\dot{x}}^{2} = \frac{1}{2} J {\dot{θ}}^{2} \qquad ( 4 )$$

which gives

$$b = \frac{{m}_{hel}}{1 + {( h / ( 2 π {r}_{4} ) )}^{2}} \frac{{( {r}_{2}^{2} - {r}_{1}^{2} )}^{2}}{{r}_{3}^{4}} = \frac{{m}_{hel}}{1 + {( h / ( 2 π {r}_{4} ) )}^{2}} {( \frac{{A}_{1}}{{A}_{2}} )}^{2} \qquad ( 5 )$$

Let mₜₒₜ=mₕₑₗ+m_{cyl} for the total liquid mass. Exemplary values are tabulated below for two different liquids used in the embodiment shown in FIG. 1. In the following examples we assume r₄=r₂+r₃, h=2r₃ and L=nh . We also take the outside diameter (OD) of the device equal to 2(r₄+r₃).

TABLE 1
A synthetic oil with ρ = 1200 kg m⁻³.

| r₁ | r₂ | r₃ | | OD | L | mₕₑₗ | m_{cyl} | mₜₒₜ | b |
|---|---|---|---|---|---|---|---|---|---|
| (mm) | (mm) | (mm) | n | (mm) | (mm) | (kg) | (kg) | (kg) | (kg) |
| 6 | 30 | 3 | 15 | 72 | 90 | 0.106 | 0.293 | 0.399 | 972.1 |
| 6 | 25 | 3 | 20 | 62 | 120 | 0.119 | 0.267 | 0.386 | 511.0 |
| 6 | 30 | 6 | 10 | 84 | 120 | 0.307 | 0.391 | 0.698 | 176.6 |
| 6 | 20 | 4 | 20 | 56 | 160 | 0.182 | 0.220 | 0.402 | 94.0 |
| 6 | 24 | 5 | 10 | 68 | 100 | 0.172 | 0.204 | 0.376 | 80.0 |
| 6 | 20 | 4 | 12 | 56 | 96 | 0.109 | 0.132 | 0.241 | 56.4 |

TABLE 2
Mercury with ρ = 13579 kg m⁻³.

| r₁ | r₂ | r₃ | | OD | L | mₕₑₗ | m_{cyl} | mₜₒₜ | b |
|---|---|---|---|---|---|---|---|---|---|
| (mm) | (mm) | (mm) | n | (mm) | (mm) | (kg) | (kg) | (kg) | (kg) |
| 6 | 20 | 4 | 12 | 56 | 96 | 1.24 | 1.49 | 2.73 | 638.4 |
| 5 | 15 | 3 | 20 | 42 | 120 | 0.87 | 1.02 | 1.89 | 428.3 |
| 5 | 10 | 2 | 30 | 28 | 120 | 0.39 | 0.38 | 0.77 | 135.5 |
| 5 | 7 | 1 | 60 | 18 | 120 | 0.13 | 0.12 | 0.25 | 74.0 |

As shown in Tables 1 and 2, the modelling and testing work demonstrated that the produced inertance effect (force proportional to acceleration) could be sufficiently large (the proportionality constant b is greater than 50 kg). Such effect would be needed where the device is placed in parallel with a spring and damper.

Furthermore, the modelling and testing demonstrated that the viscosity of the liquid provides a departure from ideal behaviour. A further parasitic element might be provided by the compressibility of the fluid which might be modelled as a spring in series with the two parallel elements.

In U.S. Pat. No. 7,316,303B, an ideal device is defined (i.e. the force proportional to relative acceleration) and deviations caused by friction, backlash etc. are regarded as parasitics which can be made as small as needed. In the case of the present invention however, the non-linear damping caused by liquid viscosity is intrinsic, and will cause a deviation from ideal behaviour at large piston velocities.

The non-linear damping of the present invention is “progressive”, namely the force increases with a relative velocity at a faster rate than linear. Practical dampers in automotive applications are often regressive, namely the force increases with a relative velocity at a slower rate than linear. Even when using ordinary liquids such as hydraulic fluids, the device according to the present invention can be configured to display an ideal behaviour, using adjusting means. For example, shim packs or valving arrangement at the orifices 6, 7 could be employed to achieve a more linear damping characteristic, although this would leave a non-negligible parallel damper. This has the potential to create a convenient integrated device with the behaviour of an ideal device according to the present with a linear damper in parallel. In other circumstances it may be advantageous not to correct for the viscosity effect.

The following details the effects of damping. Let u be the mean velocity of fluid in the helical tube, Δp the pressure drop across the piston, μ the liquid viscosity, and l the length of the helical tube, where

l=n{square root over ((h²+(2πr₄)²)} (6)

We will now calculate the pressure drop Δp across the main piston required to maintain a flow in the tube of mean velocity u. This will allow the steady force required to maintain a piston relative velocity \dot{x} to be calculated, and hence a damping coefficient. Given that A₁\dot{x}=A₂u, the Reynolds Number (Re) for the tube is equal to

$$( Re ) = \frac{2 ρ {r}_{3}}{μ} u = \frac{2 ρ {r}_{3} {A}_{1}}{μ {A}_{2}} \dot{x} \qquad ( 7 )$$

with transition from laminar to turbulent flow occurring around (Re)=2×10³. Assuming that u is small enough so that laminar flow holds, and using the Hagen-Poiseuille formula for a straight tube gives:

$$u = \frac{{r}_{3}^{2}}{8 μ} \frac{Δ p}{l} \qquad ( 8 )$$

The force on the piston required to maintain a steady relative velocity \dot{x} is equal to ΔA₁. This suggests a linear damping rate coefficient equal to:

$$c = \frac{Δ p {A}_{1}}{\dot{x}} = \frac{Δ p {A}_{1}^{2}}{{A}_{2} u} = {( \frac{{A}_{1}}{{A}_{2}} )}^{2} 8 π μ l . \qquad ( 9 )$$

The pressure drop needed to maintain a turbulent flow, according to Darcy's formula is:

$$Δ p = \frac{l}{{r}_{3}} f ρ {u}^{2} , \qquad ( 10 )$$

where f is a dimensionless friction factor. For a smooth pipe the empirical formula of Blasius is:

f=0.079(Re)^{-1/4}. (11)

This gives the following expression for the constant force on the piston required to maintain a steady velocity:

$$\begin{matrix}F = Δ p {A}_{1} \\ = 0.0664 {μ}^{0.25} {ρ}^{0.75} \frac{l {A}_{1}}{{( {r}_{3} )}^{1.25}} {u}^{1.75} \\ = 0.664 {μ}^{0.25} {ρ}^{0.75} \frac{l {A}_{1}}{{r}_{3}^{1.25}} {( \frac{{A}_{1}}{{A}_{2}} )}^{1.75} {( \dot{x} )}^{1.75} = : {{c}_{1} ( \dot{x} )}^{1.75}\end{matrix} \qquad ( 12 )$$

Let the fluid be water with ρ=100 kg m⁻³, μ=10⁻³ Pa s. Take l=7 m, r₁=8 mm, r=₂=20 mm, r₃=4 mm, L=300 mm. This results in a device with:

mₕₑₗ=0.352 kg,

m_{cyl}=0.317 kg, and

b=155 kg.

The transition to turbulent flow occurs at a piston velocity of \dot{x}=0.0119 m s⁻¹ and at velocities consistent with laminar flow, the damper rate is c=77.6 N s m⁻¹.

The pressure drop and linear force in conditions of turbulent flow are shown in FIG. 3 and FIG. 4, respectively.

If r₁, r₂ and r₃ are all increased by a factor of 2 and l is reduced by a factor of 4 and then mₕₑₗ and b are left unchanged, m_{cyl} is increased by a factor of 4 and the damping force in turbulent flow is reduced by a factor of 2^{1.25}=2.38.

Alternative configurations for the hydraulic means are equally feasible. The helical tube shown in FIG. 1 may be replaced in other embodiments of the invention with different shaped tubes. Furthermore, the liquid path may be provided inside the cylinder, with the piston being shaped to provide for example a helical liquid flow path or several concentric helices. Clearances around the piston may also be employed to provide the flow path inside the cylinder. In practice, the best results appear to be achieved by a helical flow path.

FIG. 5 shows a fluid inerter with helical channel on the outer surface of the piston whose cross-section is a semi-disk and a through-rod arranged as in the schematic of FIG. 2. FIG. 6 shows a fluid inerter with helical channel on the outer surface of the piston, a single rod as in a standard telescopic damper and a pressurised gas reservoir.

FIG. 7 illustrates an example of a force-controlling hydraulic device 10 according to the present invention. As in the device of FIG. 1, the device 10 comprises a cylinder 20, a piston 30 movable within the cylinder, and a liquid 40 within the cylinder 20. The device further comprises a helical tube 50 located outside the cylinder 20 creating a sealed path for the liquid 40 to flow out and back into the cylinder 20 via two orifices (60, 70). Accordingly, the two orifices (60, 70) represent a basic means for controlling the liquid flow in the helical tube 50. It will be appreciated that the means for controlling the liquid flow may have alternative configurations. These include for example electronic valves, computer controlled flow valves, or magnetic field generators for use with a magnetorheological fluid as will be described in more details below. Unlike the device of FIG. 1, the piston 30 according to the present invention is provided with damping means in the form of orifices 90.

Movement of the piston 30 causes liquid 40 to flow through the orifices 90 (a first flow path), generating a damping force, as well as through the helical tube 50 (a second flow path) which generates an inertial force due to the moving mass of the liquid 40. In this arrangement, the pressure drop across the external helical tube 50 is the same as the pressure drop across the piston 30. This pressure drop multiplied by the piston area is equal to the force experienced at the terminals. Accordingly, the first and second flow paths are hydraulically coupled, producing a damper coupled in series with an inerter. It will be appreciated that, instead of orifices 90, other damping means as used in conventional hydraulic dampers may be employed.

FIG. 8 schematically represents the equivalent circuit of the liquid series damper-inerter shown in FIG. 7. This circuit comprises the inerter 300 produced by the liquid 40 flowing through the helical tube 50, the parasitic (non-linear parallel damping) 200 caused by the viscous effects due to the liquid 40 through the helical tube 50, and the damper 600 produced by orifices 90 or similar damping means.

As will be described below, variations and additions to the arrangement shown in FIG. 7 are possible in practice.

FIG. 9 illustrates an example of a force-controlling hydraulic device according to the present invention. The device has a twin-tube arrangement for the construction of the external helical path and a shaft mounted damping piston. The device provides two fluid flow paths through or around the piston during compression, or extension. The movement of the piston is by-directional within the cylinder. Standard types of damper shaft, piston, and shim arrangements may be used.

A first flow path is provided through the shaft mounted damping piston. The first flow path is the traditional flow of liquid through shims, or an orifice in the main shaft piston yielding damping forces. A second helical flow path is hydraulically coupled in series with the first flow path. The helical flow path forces the liquid into spinning motion and the inertia of the rotating fluid provides inertance. The flow through the helical path also provides viscous damping.

Because both paths are hydraulically coupled, this arrangement yields a series force connection as the pressures are equalized across either path. The pressure differential across the main shaft piston translate into forces to resist, (or promote) the movement of the shaft.

The device shown in FIG. 9 is a through-rod damper version in which the shaft continues past the piston, and travels outside of the opposite side of the damper. This prevents any liquid from being displaced, and eliminates the need for a reservoir to accept displaced liquid. However, if any temperature increases are expected, a thermal expansion reservoir is typically needed. The inside-out version is a possibility, with the helical path contained within the piston and an external liquid path restricted by a fixed piston with orifices. In this arrangement, another piston with orifices attached to the through-rod achieves further damping in parallel to that obtained in the helical path and provides a means to modify the parasitic damping.

Multiple helical inserts can be added or removed to increase or decrease the length of helical flow path, making the magnitude of the inertance effect adjustable. FIGS. 10 and 11 show the helical inserts that could be stacked in the secondary flow path of the devices in FIG. 9 to add or subtract from the length of the helical flow path, and thus increase, or decrease the inertance. The inserts may be oriented using pins, or slots to align the helical path. This is particularly useful in development or devices used in racing cars.

Although the use of helical inserts has been shown and described, other embodiments include yet other means for imparting swirl to the fluid. Such swirling means include as one example a plurality of discrete, separated vanes extending semi- or fully helically in the second flow passage. Such vanes could be placed on either the inner diameter of the pressure vessel, or the outer diameter of the piston cylindrical flowpath. It is understood that it may not be necessary to provide a full, three hundred sixty degrees of fluid guidance, especially for dense and/or viscous fluids, including as one example MR fluid.

Referring again to FIG. 9, it can be seen that the inner tube in which the piston traverses has formed in it at either end one or more orifices. Some of these orifices may have placed within them one-way valves, such as check valves that provide substantially free flow of fluid in one direction, but that substantially obstruct the flow of fluid in the other direction.

Further, yet other embodiments include valves similar to the shimmed one-way valves commonly found in shock absorber pistons that provide a flow opening that varies as a function of pressure drop. In the embodiments thus described, the one-way valves act to provide an inertial component to damping that depends upon the direction of fluid flow. In such embodiments it is possible to have, as one example, relatively lighter inertial effects during jounce, and more significant inertial effects during rebound. As yet another example, the valving can be configured to provide less inertial effects at lower pressure drops across the main, stroking piston, and increased inertial effects at higher pressure drops across the stroking piston.

FIG. 12 illustrates another example of a force-controlling hydraulic device according to the present invention. This device includes a more traditional damper, having a reservoir to accept the shaft displaced liquid, and any heat expansion of the damping liquid. This single-acting rod arrangement uses an external chamber with a floating piston, as in conventional damper technology. This provides a convenient means to pressurize the device. A typical damper reservoir with or without a head-valve piston is used to accept the shaft displaced liquid, and maintain positive pressure in the damper. A pressurized gas reservoir is provided.

In some embodiments a helical insert of the type shown in FIGS. 10 and 11 can be inserted into the reservoir between the head valve and the floating piston. Such a helical insert in the reservoir can be in place of or adjunct with the helical flow path surrounding the piston in the main cylinder.

FIG. 13 illustrates another example of a force-controlling hydraulic device according to the present invention. The device is a through-rod version which in which a two-way damping piston has been added in line with the external helical fluid path to provide some additional controllable damping at lower speeds.

FIGS. 9, 12, 13 and 22 to 24 show fluid shock absorbers according to various embodiments of the present invention. In the comments that follow, it is appreciated that some of the statements may pertain to all of the embodiments shown in FIGS. 9, 12, 13 and 22 to 24, and that other comments apply to fewer than all of the embodiments shown in FIGS. 9, 12, 13 and 22 to 24. These and other figures include text which further describes the particular embodiments. That text and description are provided by way of example only, and are not to be construed as limiting.

There is an inner housing having two ends and a cylindrical inner wall. There is a piston slidable within the inner wall, the piston having two sides and coacting with the inner wall to define a first fluid volume from one side to one end and to define a second fluid volume from the other side to the other end, the piston having thereacross a first fluid passage from the one side to the other side. There is an outer housing receiving therein the inner housing, outer housing and inner housing defining a second fluid passage in fluid communication with both the first volume and the second volume, the second fluid passage curving circumferentially the outside of the inner wall. In some embodiments, the second fluid passage curves circumferentially at least about one revolution.

The outer housing has generally cylindrical inner and outer surfaces and the inner housing has generally cylindrical inner and outer surfaces. The outer housing and the inner housing define a generally annular volume therebetween, and the second fluid passage is through the annular volume.

Some embodiments also include a separate cylindrical member placed between the inner housing and the outer housing, the member including a groove extending at least one revolution about the cylindrical axis of the member, the groove coacting with at least one of the inner housing or the outer housing to define the second fluid passage. The cylindrical member can be repeatedly removable from the shock absorber. The second fluid passage comprises a plurality of the cylindrical members.

The groove of each member can be helical having an entrance and an exit, and the exit of the one cylindrical member is aligned to provide fluid to the entrance of the adjacent the cylindrical member.

The second fluid passage curves circumferentially around the inner housing a plurality of revolutions, the second passage being adapted and configured to substantially increase the angular momentum of fluid flowing therethrough. The second fluid passage can be generally spirally shaped.

The fluid flowing from one of the first volume or second volume to the other of the first volume or second volume through the second passage can be substantially confined within the helical shape.

The second fluid passage provides a flow characteristic substantially related to the inertia of the fluid flowing therethrough with relatively little viscous pressure drop, and the first pressure drop provides a flow characteristic substantially related to the velocity and viscosity of the fluid flowing therethrough. In some embodiments the viscous pressure drop of the second passage is substantially less than the viscous pressure drop of the first passage.

The first fluid passage includes a valve having a predetermined fluid flow characteristic for fluid flowing from the one side to the other side. Some embodiments also include a valve providing fluid communication from one of the first volume or the second volume to the third volume, the valve having a first predetermined fluid flow characteristic for fluid flowing into a third volume, and a second, different predetermined fluid flow characteristic for fluid flowing out of the third volume.

The outer housing includes a first attachment feature, the rod includes a second attachment feature, each attachment feature being adapted and configured for coupling to different components of a vehicle suspension. Some embodiments also include a rod having two ends, with one end being fixedly coupled to the piston and the other end extending out of the outer housing.

The fluid can be hydraulic fluid or a magnetorheological (MR) fluid. MR fluids typically contain iron particles in suspension and are therefore very dense, providing greater inertial effects as well as the possibility to adjust the viscosity by the application of a magnetic field.

The helical inserts of FIGS. 10 and 11 could be stacked in the secondary flow path of the devices in FIGS. 12 and 13 to add or subtract from the length of the helical flow path. FIG. 13 shows an embodiment in which three sets of helical inserts (each shown in cross-section) are pinned together at their opposing faces.

It will be appreciated that the helical tube shown in FIG. 7 may be replaced in other embodiments of the invention with different shaped tubes. Furthermore, as shown in FIGS. 2, 5 and 6, the liquid path may be provided inside the cylinder, with the piston being shaped to provide for example a helical flow path or several concentric helices. Clearances around the piston may also be employed to provide the flow path inside the cylinder. In practice, the best results appear to be achieved by a helical flow path. In other embodiments, it is possible to include both liquid paths within the piston such as a helical path built in a shaft assembly.

Furthermore, multiple starts and varying section geometries are envisaged for the outer helical path in a device according to the present invention. The smaller geometry helix would be “cut out” with viscous damping at an earlier stage, then leaving the larger section to produce inertance.

FIGS. 22 to 24 illustrate several options for controlling the flow of the liquid through the helical (second) path. In the embodiments of FIGS. 22 to 24, the helical path is routed through a bi-directional piston to control the inertial flow. In the embodiments of FIGS. 22 to 24, a pressurised gas reservoir is used to pressurize the system and allow for heat expansion, however, it is also possible to use a through-rod arrangement in which there is no displaced fluid from the damper to be accommodated by the gas reservoir.

An externally adjustable inertance is envisaged for a device according to the present invention in which the inner tube of the device is axially adjustable in relation to the helical path providing the first flow path. When moved, this would set the starting point of the helical column of fluid effectively adding or removing portions of the helical path, and hence changing the inertance.

FIG. 23 shows an embodiment wherein external adjusters are used to control the flow in the damping and inertial paths, respectively. Adjusters may be any type of bleed, blowoff, shim preload, or other type of adjuster.

Furthermore, as shown in the embodiment of FIG. 24, it is possible to use computer controlled bypass valves to work in conjunction with the layout according to the present invention. A computer controlled valve could be used to control bypass flow around the helical path, but might also be able to separately control the inertance by controlling the flow through the helical path.

When an MR fluid is used in an embodiment as shown in FIG. 24, it is possible to adjust its viscosity by a magnetic field. Magnetic field generators could be used to vary the damping characteristic in the first and or the second flow path.

Devices according to the present invention may be installed for example inside a motorcycle fork or inside an automobile strut to provide motion control.

It will be appreciated that integrated devices involving devices according to the present invention can be made. Three examples in FIGS. 14, 16, and 18 are now given in which another device acts in parallel with a device according to the present invention.

FIG. 14 shows a series damper-inerter in parallel with a damper 121. The device comprises two separate fluid chambers 124 and 122. The device is equipped with a rod 128 which acts as a through-rod in the chamber 124. Pistons 131 and 132 are attached to the rod. The chamber 124 provides the operation of a device of the type 10 (shown in FIG. 7) which comprises an external fluid-filled helical path 125, inlet and outlet ports 126 and 127 and an orifice 123 in the piston 131. The helical path 125 provides the inerter effect (first flow path) and the orifice 123 provides the damper in series (second flow path). The second chamber 122 provides a parallel damper by means of the orifice 133 in the piston 132. The chamber 122 is equipped with an external chamber 130 and floating piston 129 to accommodate fluid displaced by the rod. This chamber may also serve to pressurise the device.

FIG. 15 shows the circuit diagram for the device according to FIG. 14 comprising a damper 161 in parallel with the series connection of a damper 162 and inerter 163. Any parasitic damping from the helical path or damping deliberately introduced would act in parallel with the inerter element alone.

FIG. 16 shows a series damper-inerter in parallel with an inerter 141. The device comprises two separate fluid chambers 144 and 142. The device is equipped with a rod 148 which acts as a through-rod in the chamber 144. Pistons 151 and 152 are attached to the rod. The chamber 144 provides the operation of a device of the type 10 (shown in FIG. 7) which comprises an external fluid-filled helical path 145, inlet and outlet ports 146 and 147 and an orifice 143 in the piston 151. The helical path 145 provides the inerter effect (first flow path) and the orifice 143 provides the damper in series (second flow path). The second chamber 142 provides a parallel inerter by means of the external helical path 155. The chamber 142 is equipped with an external chamber 150 and floating piston 149 to accommodate fluid displaced by the rod. This chamber may also serve to pressurise the device.

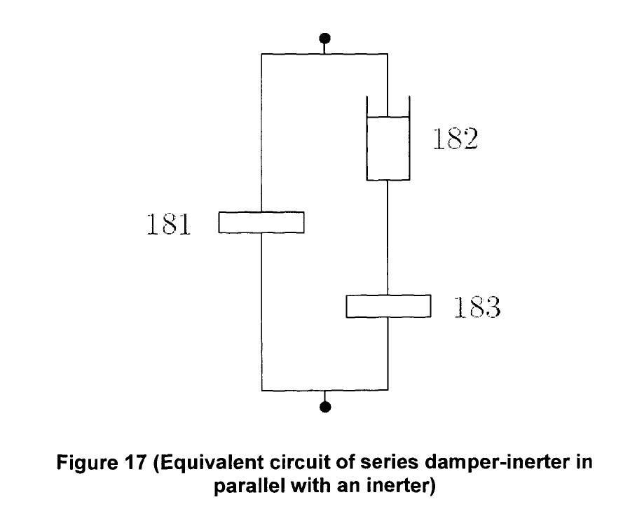

FIG. 17 shows the circuit diagram for the device according to FIG. 16 comprising an inerter 181 in parallel with the series connection of a damper 182 and inerter 183. Any parasitic damping from the helical paths or damping deliberately introduced would act in parallel with the inerter elements.

FIG. 18 shows a series damper-inerter in parallel with a series connection of a spring damper and inerter 221. The device comprises two separate fluid chambers 224 and 222. The device is equipped with a rod 228 which acts as a through-rod in the chamber 224. Piston 231 is attached to the rod 228. Spring-loaded piston 232 is slidably attached to the rod 228 by the spring 234. The chamber 224 provides the operation of a device of the type 10 (shown in FIG. 7) which comprises an external fluid-filled helical path 225, inlet and outlet ports 226 and 227 and an orifice 223 in the piston 231. The helical path 225 provides the inerter effect (first flow path) and the orifice 223 provides the damper in series (second flow path). The second chamber 222 provides in parallel a series inerter-spring-damper by means of the external helical path 235, the spring-loaded piston 232 and the orifice 233 in the piston. The chamber 222 is equipped with an external chamber 230 and floating piston 229 to accommodate fluid displaced by the rod. This chamber may also serve to pressurise the device.

FIG. 19 shows the circuit diagram for the device according to FIG. 18 comprising a series connection of a damper 241 and inerter 242 in parallel with a series connection of a spring 243 damper 244 and inerter 245. Any parasitic damping from the helical path or damping deliberately introduced would act in parallel with the inerter elements alone.

FIG. 20 shows a device 321 according to the present invention. The device 321 comprises a cylinder 322, a rod 328 movable within the cylinder, and a fluid 324 within the cylinder 322. There is provided a piston 331 fixed to the rod 328 with an orifice 323 and a further spring-loaded piston 332 slidably attached to the rod 328. The device further comprises a helical tube 325 located outside the cylinder 322 creating a sealed path for the fluid to flow out and back into the cylinder 322 via two orifices (326, 327). Movement of the rod causes fluid 324 to flow through helical tube 325 which generates an inertial force due to the moving mass of the fluid 324. As in the device of FIG. 7, the piston 331 is provided with damping means in the form of the orifice 323. The second spring-loaded piston 332 provides the effect of a spring in parallel. The device 321 is equipped with an external chamber 329 and floating piston 330 to accommodate fluid displaced by the rod. This chamber may also serve to pressurize the device.

FIG. 21 shows the circuit diagram for the device according to FIG. 20 comprising the connection of an inerter 341 in series with a parallel connection of a spring 342 and damper 343.

1.-25. (canceled)

26. A fluid shock absorber, comprising:
an inner housing having two ends and a cylindrical inner wall;
a piston slidable within the inner wall, said piston having two sides and coacting with the inner wall to define a first fluid volume from one side to one end and to define a second fluid volume from the other side to the other end, said piston having thereacross a first fluid passage from the one side to the other side;
an outer housing receiving therein said inner housing, said outer housing and said inner housing defining a second fluid passage in fluid communication with both the first volume and the second volume, the second fluid passage curving circumferentially at least one revolution around the outside of the inner wall.

27. A fluid shock absorber according to claim 26, wherein said outer housing has generally cylindrical inner and outer surfaces and said inner housing has generally cylindrical inner and outer surfaces.

28. A fluid shock absorber according to claim 26, wherein said outer housing and said inner housing define a generally annular volume therebetween, and the second fluid passage is through the annular volume.

29. A fluid shock absorber according to claim 26, further comprising a separate cylindrical member placed between said inner housing and said outer housing, said member including a groove extending at least one revolution about the cylindrical axis of said member, said groove coacting with at least one of said inner housing or said outer housing to define the second fluid passage.

30. A fluid shock absorber according to claim 29, wherein said cylindrical member is repeatedly removable from said shock absorber.

31. A fluid shock absorber according to claim 29, wherein the second fluid passage comprises a plurality of said cylindrical members.

32. A fluid shock absorber according to claim 31, wherein the groove of each said member is helical having an entrance and an exit, and the exit of one said cylindrical member is aligned to provide fluid to the entrance of the adjacent said cylindrical member.

33. A fluid shock absorber according to claim 29 wherein the groove is helical.

34. A fluid shock absorber according to claim 26, wherein the second fluid passage curves circumferentially around the inner housing a plurality of revolutions, the second passage being adapted and configured to substantially increase the angular momentum of fluid flowing therethrough.

35. A fluid shock absorber according to claim 26, wherein the second fluid passage is generally spirally shaped.

36. A fluid shock absorber according to claim 26, wherein the second fluid passage is helically shaped.

37. A fluid shock absorber according to claim 36, wherein fluid flowing from one of the first volume or second volume to the other of the first volume or second volume through the second passage is substantially confined within the helical shape.

38. A fluid shock absorber according to claim 26, wherein the second fluid passage provides a flow characteristic substantially related to the inertia of the fluid flowing therethrough, and the first pressure drop provides a flow characteristic substantially related to the viscosity of the fluid flowing therethrough.

39. A fluid shock absorber according to claim 26, wherein the viscous pressure drop of the second passage is substantially less than the viscous pressure drop of the first passage.

40. A fluid shock absorber according to claim 26, wherein the first fluid passage includes a valve having a predetermined fluid flow characteristic for fluid flowing from the one side to the other side.

41. A fluid shock absorber according to claim 26, wherein one of the first volume or the second volume is in fluid communication with a third volume, said means having a first predetermined fluid flow characteristic for fluid flowing into the third volume, and a second, different predetermined fluid flow characteristic for fluid flowing out of the third volume.

42. A fluid shock absorber according to claims 26, wherein said outer housing includes a first attachment feature, said rod includes a second attachment feature, each said attachment feature being adapted and configured for coupling to different components of a vehicle suspension.

43. A fluid shock absorber according to claim 26, further comprising a rod having two ends, with one end being fixedly coupled to said piston and the other end extending out of said outer housing.

44. A fluid shock absorber according to claim 26, wherein said fluid is hydraulic fluid.

45. A fluid shock absorber according to claim 26, further comprising means to control the flow along the first fluid passage.

46. A fluid shock absorber according to claim 26, further comprising means to control the flow along the second fluid passage.

47. A fluid shock absorber according to claim 43, wherein the means to control the flow is a computer-controlled valve.

48. A fluid shock absorber according to claim 46, wherein the means to control the flow include external means for adjusting the length of the second fluid passage.

49. A fluid shock absorber according to claim 45, wherein the fluid is magnetorheological fluid and wherein the means to control the flow are means for magnetorheological fluid control.

50. A fluid shock absorber, comprising:
an inner housing having two ends and a length therebetween, and a cylindrical inner wall;
a piston slidable within the inner wall, said piston having two sides and coacting with the inner wall to define a first fluid volume from one side to one end and to define a second fluid volume from the other side to the other end, said piston having thereacross a first fluid passage from the one side to the other side;
an outer housing receiving therein said inner housing, said outer housing and said inner housing defining a second fluid passage having two ends and extending along at least a portion of the length of said inner housing, the second fluid passage extending circumferentially around the outside of the inner wall; and
a valve for providing fluid communication between one end of the first fluid passage and one end of the second fluid passage, wherein the valve has a predetermined fluid flow characteristic for fluid flowing between the two fluid passages.

51. A fluid shock absorber according to claim 50 wherein said valve is a shimmed check valve.

52. A fluid shock absorber according to claim 50 wherein said valve provides fluid to one side of a piston within a gas-pressurized reservoir.

53. A fluid shock absorber according to claim 50 wherein the predetermined fluid flow characteristic is externally adjustable.

54. The fluid shock absorber of claim 50 wherein the first fluid passage has a first flow characteristic that provides more viscous pressure drop than the second flow characteristic of the second fluid passage.

55. The fluid shock absorber of claim 50 which further comprises a magnetorheological fluid in the first and second passages and wherein said valve is electrically actuatable to produce a magnetic field in said fluid.

56. The fluid shock absorber of claim 50, wherein the second fluid passage extends circumferentially at least one revolution.

57. The fluid shock absorber of claim 50 which further comprises means for swirling the fluid in the second passage.

58. The fluid shock absorber of claim 50 wherein the first fluid passage is adapted and configured such that there is substantially no fluid flow through the first fluid passage if the piston stroking velocity is slower than a predetermined limit.

59. The fluid shock absorber of claim 50 wherein the first fluid includes a pair of shimmed, one way valves, with one said valve oriented to prevent flow from one side to the other side, and the other valve oriented to prevent flow from the other side to the one side.

60. A mechanical system for motion control, such as a system within a car suspension, a railway suspension, or a motorcycle suspension, comprising a fluid shock absorber according to claim 26.

61. A method for motion control, comprising the step of employing a fluid shock absorber according to claim 26.
